(19) United States
(12) Patent Application Publication
(10) Pub. No.: US 2008/0303685 A1
(43) Pub. Date: Dec. 11, 2008

(54) INSTALLATION STRUCTURE OF CAPACITANCE SENSOR AND ASSEMBLY METHOD OF THE SAME

(75) Inventors: Ryuichi Nakano, Wako-shi (JP); Taizo Kikuchi, Wako-shi (JP); Hiroshi Masuko, Kiryu-shi (JP); Yasunori Noro, Kiryu-shi (JP); Hiroshi Misawa, Kiryu-shi (JP); Yukinori Kurumado, Kyoto-shi (JP); Keiichi Nagayama, Kyoto-shi (JP)

Correspondence Address: RANKIN, HILL & CLARK LLP, 38210 Glenn Avenue, WILLOUGHBY, OH, 44094-7808, US

(73) Assignees: HONDA MOTOR CO., LTD., Tokyo (JP); MITSUBA CORPORATION, Kiryu-shi (JP); OMRON CORPORATION, Kyoto-shi (JP)

(21) Appl. No.: 12/056,522

(22) Filed: Mar. 27, 2008

(30) Foreign Application Priority Data
Mar. 28, 2007 (JP) 2007-083577

(51) Int. Cl. G08B 21/00

(52) U.S. Cl. 340/686.6

(57) ABSTRACT

A structure for installing a capacitance sensor which detects an object in vicinity of the capacitance sensor to a door of a vehicle, including a spacer disposed between the door and the capacitance sensor attached at a vehicle-inner side of an opening end of the door. A water-drop prevention portion is formed on an outer surface of the spacer for preventing water from flowing to the capacitance sensor from the door.

### CROSS REFERENCE TO RELATED APPLICATIONS

This application claims the foreign priority benefit under 35 U.S.C. §119 of Japanese Patent Application No. 2007-83577 filed on Mar. 28, 2007, the disclosure of which is incorporated herein by reference.

### BACKGROUND OF THE INVENTION

1. Field of the Invention

The present invention relates to a structure for installing a capacitance sensor used for a vehicle door to detect an object in the vicinity of the capacitance sensor and a method for assembling the structure.

2. Description of the Related Art

Conventionally, apparatuses for preventing a hand or a finger from being caught between a power slide door of a vehicle and a pillar for receiving the power slide door have been known. An apparatus equipped with a capacitance sensor has been widely known as such an apparatus (e.g. disclosed in Japanese Laid-open Patent Application No. 2004-219311). FIG. 6A referred to herein is a cross-sectional view along the horizontal direction of a vehicle showing a conventional installation structure of a capacitance sensor. FIG. 6B is a graph showing change in the value of potential difference detected by the capacitance sensor when an object is in the vicinity of the capacitance sensor. The upper side of FIG. 6A shows outside of the vehicle, and the lower side thereof shows inside of the vehicle. The vertical axis of FIG. 6B represents a voltage (V), which is the value of potential difference, and the horizontal axis represents time (second).

As shown in FIG. 6A, in an installation structure Sp, a capacitance sensor 52 is connected to the vehicle-inner side of a door hem 55 through a bracket 53 such that a predetermined distance is maintained between the capacitance sensor 52 and the door hem 55. When an object such as a human body approaches a closing door 50, the capacitance sensor 52 detects the object based on change in capacitance between the capacitance sensor 52 and the object. Generally, a differential capacitance sensor (e.g. disclosed in Japanese Laid-open Patent Application No. 2004-219311) can be configured such a manner that a first sensing electrode and a second sensing electrode are disposed such that a distance between an approaching object and the first sensing electrode is different from that between the approaching object and the second sensing electrode. In a capacitance sensor with such a configuration, when a voltage, which is the potential difference between the first sensing electrode and the second sensing electrode, is more than or equal to a predetermined threshold value, it is assumed that an object such as a human body is in the vicinity of the capacitance sensor. In short, as shown in FIG. 6B, when a voltage, which is the potential difference, exceeds a predetermined threshold value from a predetermined reference voltage, an object such as a human body is assumed to be in the vicinity of the capacitance sensor.

In the conventional installation structure Sp of the capacitance sensor 52, however, because the capacitance sensor 52 is installed in the vicinity of an edge 55A of the door hem 55 as shown in FIG. 6A, when water W flows in a direction D2 from the outer surface of the door hem 55 toward the edge 55A (e.g. when a vehicle is parked on a downhill while raining), the water W may electrically connect a detection surface 57 of the capacitance sensor 52 and the door hem 55 which is set to be grounding potential. This causes the capacitance sensor 52 to malfunction as if the capacitance sensor 52 detected a human body as shown in FIG. 6B.

In the conventional installation structure Sp, the capacitance sensor 52 is installed such that a predetermined distance is maintained between the door hem 55 and the sensor 52 as described above. Thus, when a passenger getting in and out a vehicle comes in contact with the capacitance sensor 52, a bracket 53 may be deformed, causing the capacitance sensor 52 to be displaced toward the door hem 55. In short, there is a problem that the installation structure Sp of the capacitance sensor 52 is easy to be deformed by external force. If the installation structure Sp is deformed such that the capacitance sensor 52 comes close to the door hem 55, malfunction of the capacitance sensor 52 caused by the water W occurs more easily.

In the conventional installation structure Sp of the capacitance sensor 52, the distance between the door hem 55 and the capacitance sensor 52 needs to be adjusted with high accuracy. Thus, there are also problems that an installation process becomes complicated and time-consuming because of the measurement of the distance between the door hem 55 and the capacitance sensor 52 and the positioning of the capacitance sensor 52 and the like when installing the capacitance sensor 52.

### SUMMARY OF THE INVENTION

An object of the present invention is to provide an installation structure of a capacitance sensor which is difficult to be deformed even if external force is applied, enables to reliably prevent malfunction of the capacitance sensor caused by water, and with which the installation process of the capacitance sensor is easy and less time-consuming and a method for assembling the installation structure.

A first aspect of the present invention provides a structure for installing to a door of a vehicle a capacitance sensor which detects an object in vicinity of the capacitance sensor, including a spacer provided between the door and the capacitance sensor disposed at a vehicle-inner side of an opening end of the door, and the spacer having a water-drop prevention portion formed on an outer surface of the spacer for preventing water from flowing to the capacitance sensor from the door.

In the aforementioned structure, the water-drop prevention portion is formed in a lip-shape to be folded backward in an opposite direction to a water flowing direction.

In the aforementioned structure, the spacer includes a spacing portion which is in contact with the door and the capacitance sensor, and a buffering portion which is a space formed along at least one of the door and the capacitance sensor.

In the aforementioned structure, the spacer includes a door-side engaging portion for engaging an edge of the door, and a bracket-side engaging portion for engaging a bracket which connects the capacitance sensor to the vehicle-inner side of the door hem of the door.

In the aforementioned structure, the spacer is integrally formed with an outer cover portion of the capacitance sensor.

A second aspect of the present invention provides a method for assembling an installation structure of a capacitance sensor attached to a vehicle inner side of an opening end of a door of a vehicle via a bracket, in which a spacer is sandwiched between the capacitance sensor and the door, the spacer including a door-side engaging portion for engaging an edge of the door, and a bracket-side engaging portion for engaging a bracket which connects the capacitance sensor to a vehicle-inner side of the door, and a water-drop prevention portion for preventing water from flowing to the capacitance sensor from the door, the method including steps of a step of connecting the capacitance sensor to the bracket and engaging the bracket-side engaging portion with the bracket so as to form a sensor unit including the capacitance sensor, the spacer and the bracket, a step of engaging the door-side engaging portion of the spacer included in the sensor unit with the edge of the door, and a step of attaching the bracket included in the sensor unit to the vehicle-inner side of the door.

Other features and advantages of the present invention will become more apparent from the following detailed descriptions of the invention when taken in conjunction with the accompanying drawings.

### BRIEF DESCRIPTION OF THE DRAWINGS

FIG. 1 is a perspective view showing the exterior appearance of an installation structure of a capacitance sensor according to an embodiment of the present invention.

FIG. 2 is a cross-sectional view along A-A line in FIG. 1.

FIG. 3A is a cross-sectional view along the horizontal direction of a vehicle showing the flow of water in the installation structure of the capacitance sensor according to the embodiment.

FIG. 3B is a graph showing change in the value of potential difference detected by the capacitance sensor when water flows. The vertical axis in FIG. 3B represents a voltage (V), which is the value of the potential difference, and the horizontal axis represents time (second)

FIGS. 4A to 4C are process drawings for describing a method for assembling the installation structure of the capacitance sensor.

FIG. 5 is a cross-sectional view along a line corresponding to the A-A line in FIG. 1, showing an installation structure of a capacitance sensor according to another embodiment.

FIG. 6A is a cross-sectional view along the horizontal direction of a vehicle showing a conventional installation structure of a capacitance sensor.

FIG. 6B is a graph showing change in the value of potential difference detected by the capacitance sensor when an object is in the vicinity of the capacitance sensor. The vertical axis of FIG. 6B represents a voltage (V), which is the value of potential difference, and the horizontal axis represents time (second)

### DETAILED DESCRIPTION OF THE INVENTION

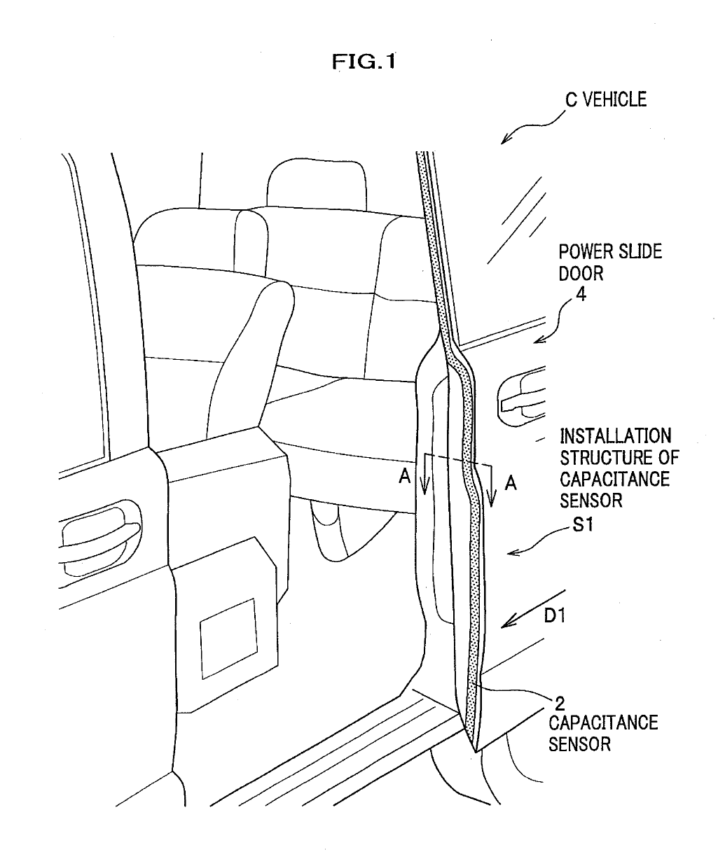

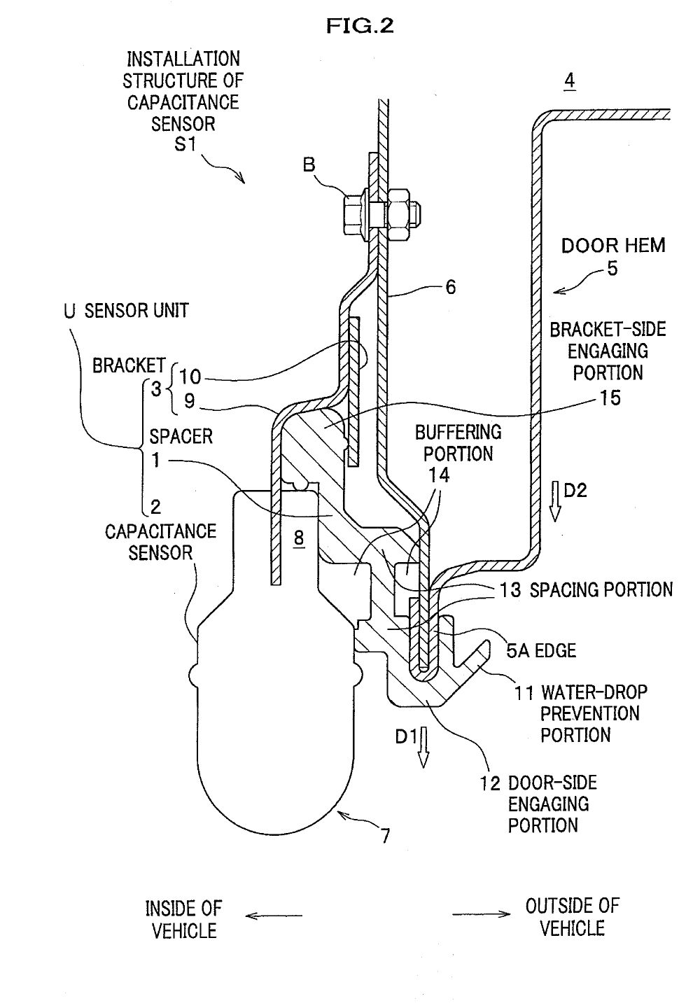

Embodiment of an installation structure of a capacitance sensor according to the present invention is described below with reference to the accompanying drawings. FIG. 1 is a perspective view showing the exterior appearance of the installation structure of the capacitance sensor according to the embodiment of the present invention. FIG. 2 is a cross-sectional view along A-A line in FIG. 1.

As seen in FIG. 1, the installation structure S1 of the capacitance sensor according to the embodiment (hereinafter also referred to just as the “installation structure S1”) includes a differential capacitance sensor 2 and is applied to a power slide door 4 of a vehicle (automobile) C. As known by those skilled in the art, the differential capacitance sensor 2 (hereinafter also referred to just as a “sensor 2”) detects an object such as a human body approaching to the sensor 2 based on the value of the potential difference of a pair of sensing electrodes (not shown). The sensor 2 is formed long in a vertical direction and is installed on a vehicle-inner side of an opening end of a closing direction D1 side of the power slide door 4, extending from its top end to its bottom end. More specifically, as shown in FIG. 2, the sensor 2 is disposed at a vehicle-inner side of the door hem 5 such that a detection surface 7 of the sensor 2 faces toward the side of closing direction D1 shown in FIG. 1.

The installation structure S1 mainly includes a spacer 1 disposed between the sensor 2 and the door hem 5, and a bracket 3 for connecting the sensor 2 to the door hem 5 as shown in FIG. 2.

The spacer 1 is sandwiched between the door hem 5 and the sensor 2 so as to make a predetermined distance between the door hem 5 and the sensor 2. The spacer 1 is also formed long in a vertical direction and is disposed along the longitudinal direction of the sensor 2. Specifically, the spacer 1 extends from the top end of the opening end of the closing direction D1 of the power slide door 4 shown in FIG. 1 to the bottom end thereof. The spacer 1 according to the embodiment is formed of elastic material such as synthetic rubber and other resin material.

As shown in FIG. 2, the spacer 1 includes a door-side engaging portion 12 which engages an edge 5A of the door hem 5, and a bracket-side engaging portion 15 which engages the bracket 3. The edge 5A of the door hem 5 is also referred to as “an edge of a door”.

The door-side engaging portion 12 is formed in substantially U-shape in cross-section, and sandwiches the edge 5A of the door hem 5 in a gap defined by the U-shape. The bracket-side engaging portion 15 is also sandwiched by the bracket 3 at the vicinity of an engaging portion 8 of the sensor 2 which is described later. In other words, the spacer 1 is supported at the edge 5A of the door hem 5 by the door-side engaging portion 12 and is also supported at the bracket 3 by the bracket-side engaging portion 15.

The spacer 1 further includes a water-drop prevention portion 11, a spacing portion 13 and a buffering portion 14 which are major characteristics of the present invention.

The water-drop prevention portion 11 is formed in lip-shape in cross-section extending toward outside of the vehicle from the door-side engaging portion 12. The water-drop prevention portion 11 is formed leaning toward the door hem 5. Specifically, the water-drop prevention portion 11 is formed being folded back in an opposite direction to a direction in which water flows toward the sensor 2 from the outer surface (the surface of a vehicle-outer side) of the door hem 5.

The spacing portion 13 according to the present invention is formed at two positions between the door-side engaging portion 12 and the bracket-side engaging portion 15 such that the spacing portion 13 is in contact with the door hem 5 and the sensor 2. The spacer 1 is designed to maintain a predetermined distance between the door hem 5 and the sensor 2 by the spacing portion 13. The spacing portion 13 may be formed at one or three places in the spacer 1.

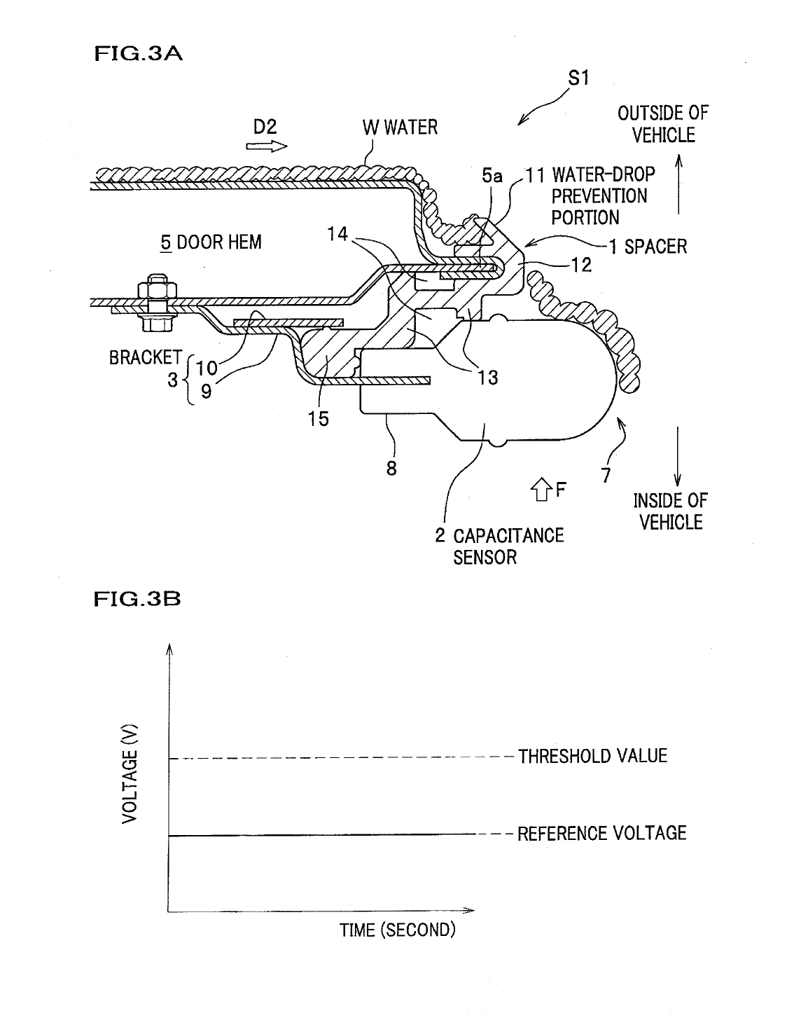

The buffering portions 14 according to the embodiment are formed between the door-side engaging portion 12 and the bracket-side engaging portion 15, and are composed of a space between the door hem 5 and the spacer 1 and a space between the sensor 2 and the spacer 1. Specifically, the buffering portions 14 according to the embodiment are formed adjacent to the spacing portion 13. The buffering portions 14 allow the spacer 1 (the spacing portion 13) to easily deform when external force F (refer to FIG. 3A) is applied from inside of the vehicle, which is described later. The buffering portion 14 may be composed only of a space between the door hem 5 and the spacer 1 or a space between the sensor 2 and the spacer 1.

The bracket 3 is mainly composed of a main bracket 9 and a supplementary bracket 10. Each of the main bracket 9 and the supplementary bracket 10 is formed of a long plate member extending from the top end to the bottom end of the opening end of the power slide door (i.e. along the longitudinal direction of the sensor 2) at the side of the closing direction D1 shown in FIG. 1.

The main bracket 9 connects the sensor 2 to an inner panel 6 of the door hem 5 as described above. The main bracket 9 according to the embodiment is substantially a crank shape in cross-section, and an end thereof is inserted into the engaging portion 8 of the sensor 2 so as to connect the main bracket 9 to the sensor 2. At least at one place, the spacing portion 13 is sandwiched between the engaging portion 8 of the sensor 2 into which the end of the main bracket 9 is inserted and the door hem 5. In short, the spacing portion 13 is in contact with the engaging portion 8 of the sensor 2.

The other end of the main bracket 9 extending from the engaging portion 8 to the inner panel 6 is fixed to the inner panel 6 by a bolt B. The main bracket 9 is fixed to the inner panel 6 by a plurality of bolts B at a plurality of places along the longitudinal direction of the main bracket 9. It is to be understood that the main bracket 9 may be welded to the inner panel 6.

The supplementary bracket 10 is formed of a flat plate and is connected to the main bracket 9 such that the spacer 1 (the bracket-side engaging portion 15) is sandwiched between the supplementary bracket 10 and the main bracket 9. As a result, the bracket-side engaging portion 15 is supported by the bracket 3 at the vicinity of the engaging portion 8 of the sensor 2.

Effects of the installation structure S1 according to the embodiment are explained with reference to the accompanying drawings. FIG. 3A referred to herein is a cross-sectional view along the horizontal direction of a vehicle showing the flow of water in the installation structure of the capacitance sensor according to the embodiment. FIG. 3B is a graph showing change in the value of potential difference detected by the capacitance sensor when water flows. The upper side of FIG. 3A is outside of the vehicle, and the lower side thereof is inside of the vehicle. The vertical axis of FIG. 3B represents a voltage (V), which is the value of the potential difference, and the horizontal axis represents time (second).

As shown in FIG. 2, the water-drop prevention portion 11 of the installation structure S1 is formed being folded backward in an opposite direction to a direction D2 in which water flows toward the sensor 2 from the outer surface of the door hem 5. Thus, in accordance with the installation structure S1, for example, even when the vehicle C (refer to FIG. 1) is parked on a downhill while raining, water W flowing in the direction D2 from the outer surface of the door hem 5 to the sensor 2 is stopped at the water-drop prevention portion 11 as shown in FIG. 3A. Thus, the installation structure S1 prevents a detection surface 7 of the differential capacitance sensor 2 and the door hem 5, which is set to be a grounding potential, from being electrically connected to each other by the water W. As a result, the value of the potential difference detected by the sensor 2 does not exceed a threshold value and is maintained at reference voltage as shown in FIG. 3B. Thus, in accordance with the installation structure S1, malfunction of the sensor 2 is prevented.

In the installation structure S1, the water-drop prevention portion 11 is in lip-shape where the water-drop prevention portion 11 is folded back in the direction opposite to the direction D2 in which water W flows. Thus, in accordance with the installation structure S1, it is possible to securely prevent the door hem 5 and the sensor 2 from being electrically connected to each other by the water W. As a result, the installation structure S1 can prevent malfunction of the sensor 2 more reliably.

In the installation structure S1, the spacer 1 is disposed between the door hem 5 and the sensor 2 and the spacing portion 13 of the spacer 1 comes in contact with the door hem 5 and the sensor 2 such that a predetermined distance is maintained between the door hem 5 and the sensor 2. As a result, in the installation structure S1, even if external force F is applied from inside of the vehicle to the sensor 2, the sensor 2 is not displaced toward the door hem 5. Thus, in accordance with the installation structure S1, it is possible to stable the detection function of the sensor 2 for detecting an object as well as to reliably prevent malfunction of the sensor 2 caused by the water W.

In the installation structure S1, because a distance between the door hem 5 and the sensor 2 is maintained appropriately by the spacer 1 as described above, when the sensor 2 is connected to the door hem 5, dimensional control such as measurement of the distance between the door hem 5 and the sensor 2 or positioning of the sensor 2 is not necessary. Thus, in the installation structure S1, it is possible to facilitate a process for connecting the sensor 2 and to reduce the time required for the process. In short, the installation structure S1 improves workability of the process for connecting the sensor 2 to the door hem 5.

In the installation structure S1, at least at one place, the spacing portion 13 provided with the spacer 1 is in contact with the engaging portion 8 of the sensor 2 into which an end of the main bracket 9 is inserted. In accordance with the installation structure S1, because the spacing portion 13 is in contact with the engaging portion 8 with high stiffness in the sensor 2, the distance between the door hem 5 and the sensor 2 is securely maintained, whereby the connection strength of the sensor 2 can be made large.

Because the spacer 1 of the installation structure S1 includes the buffering portion 14 and the spacing portion 13, the spacer 1 is allowed to be elastically deformed. Thus, the installation structure S1 makes it possible to stable the installation status of the sensor 2 to the door hem 5.

In the installation structure S1, because the spacer 1 includes the buffering portion 14 so as to make the spacing portion 13 to elastically deform easily, when the external force F is applied from inside of the vehicle to the sensor 2, the sensor 2 is prevented from being impaired by the external force F.

In the installation structure S1, when the spacer 1, the sensor 2 and the bracket 3 are combined in advance as a sensor unit U (refer to FIG. 2), it is possible to streamline a process for assembling the installation structure S1.

In the installation structure S1, the spacer 1 is supported toward the edge 5A of the door hem 5 at the door-side engaging portion 12 and is also supported toward the bracket 3 at the bracket-side engaging portion 15. Thus, the installation structure S1 allows the spacer 1 to be stably fixed between the door hem 5 and the sensor 2.

In the installation structure S1, because at least at one place, the spacing portion 13 is sandwiched between the engaging portion 8 of the sensor 2 into which the end of the main bracket 9 is inserted and the door hem 5, it is possible to connect the sensor 2 to the door hem 5 more securely, which is different from a conventional installation structure with which the spacer 1 is not provided.

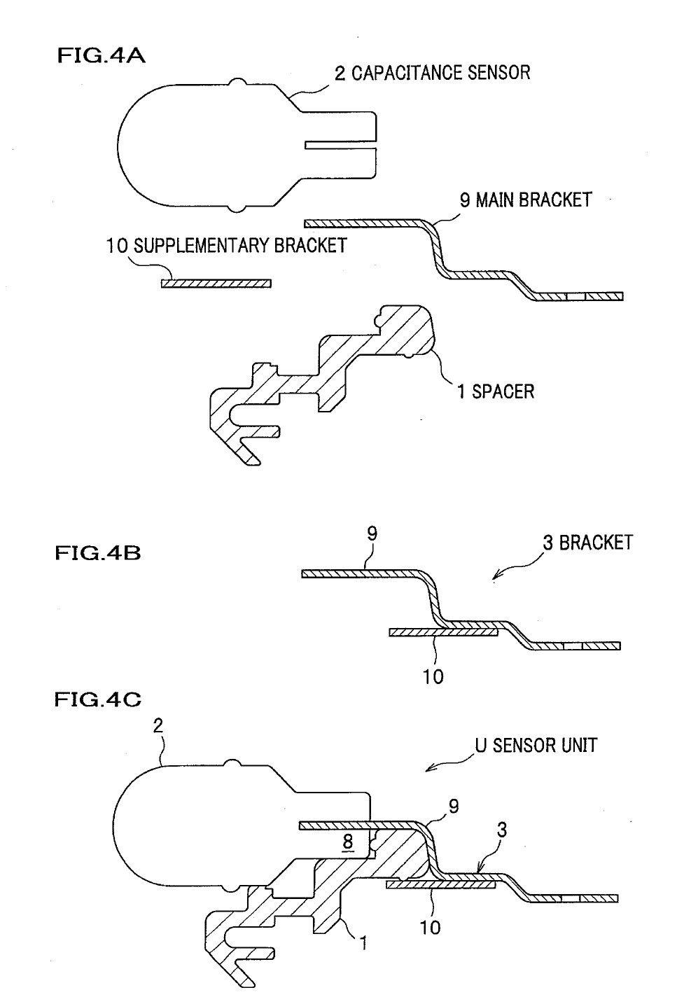

Next, a method for assembling the installation structure S1 according to the embodiment is described with reference to the accompanying drawings. FIGS. 4A to 4C referred to herein are process drawings for describing the method for assembling the installation structure S1 of the capacitance sensor.

In this method, the sensor 2, the main bracket 9, the supplementary bracket 10 and the spacer 1 are prepared as shown in FIG. 4A.

In this method, the main bracket 9 and the supplementary bracket 10 are connected, for example, by welding or by fastening a bolt or a rivet to form the bracket 3 as shown in FIG. 4B.

Then, in this method, the engaging portion 8 of the sensor 2 is attached to an end of the main bracket 9 and the bracket-side engaging portion 15 of the spacer 1 is sandwiched between the main bracket 9 and the supplementary bracket 10 to form the sensor unit U as shown in FIG. 4C.

Then, in this method, the edge 5A of the door hem 5 is fitted into the door-side engaging portion 12 of the spacer 1 which constitutes the sensor unit U as shown in FIG. 2, and the other end of the main bracket 9 is attached to the door hem 5 from inside of the vehicle by the bolt B, and thus the installation structure S1 of the sensor 2 is completed.

In the method, the sensor unit U composed of the sensor 2, the spacer 1 and the bracket 3 is formed in advance and the sensor unit U is attached to the door hem 5. Thus, in accordance with the method, workability of the process for connecting the sensor 2 to the door hem 5 can be improved, compared with an assembling method in which the sensor 2, the spacer 1 and the bracket 3 are connected to the door hem 5 individually.

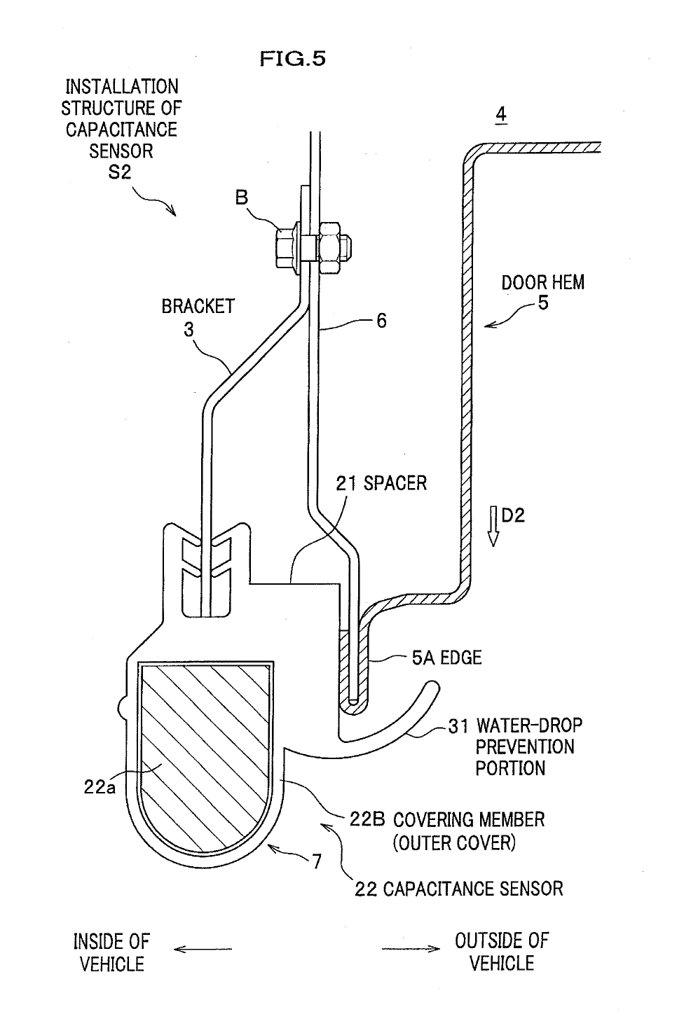

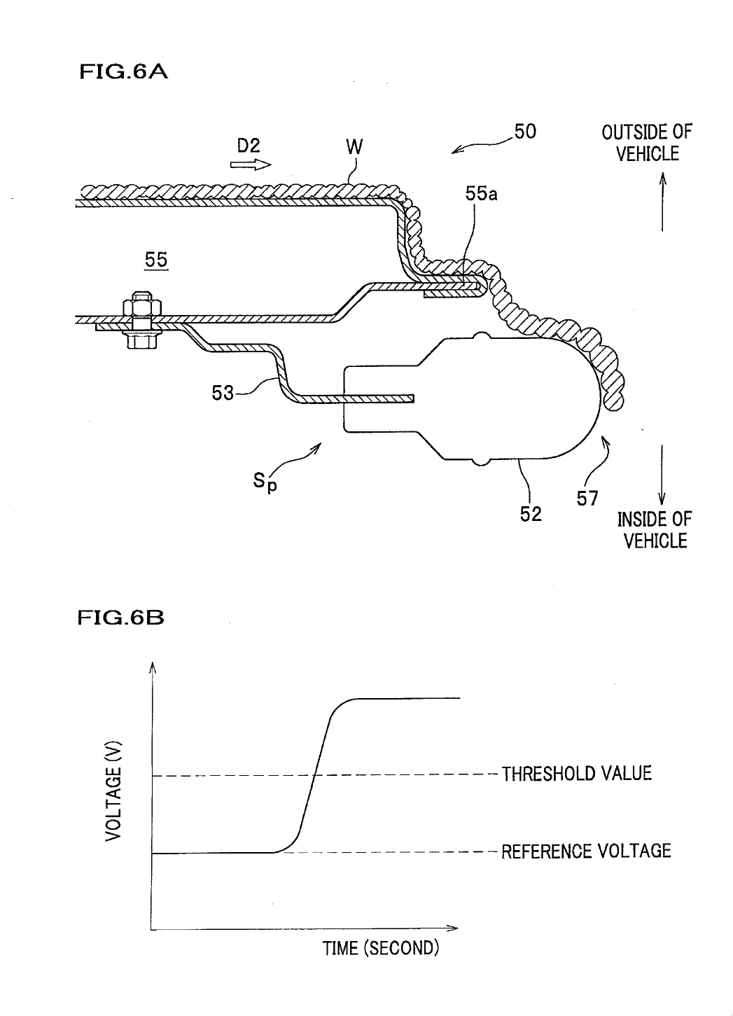

Although the embodiment according to the present invention is described as above, the present invention is not limited to the embodiment. In the embodiment, the spacer 1 and the sensor 2 are formed of different members, however, the spacer 1 and the sensor 2 may be integrally molded. FIG. 5 referred to herein is a cross-sectional view along a line corresponding to the A-A line in FIG. 1, showing an installation structure of a capacitance sensor according to another embodiment. In the installation structure according to the another embodiment, similar reference characters refers to components corresponding to the components in the installation structure S1 according to the embodiment, and the description thereof will be omitted.

As shown in FIG. 5, in an installation structure S2, a covering member 22B for covering a sensor main unit 22A of a differential capacitance sensor 22 (may also be referred to just as a “sensor S2” hereinafter) is integrally formed with the spacer 21. More specifically, in the installation structure S2, the spacer 21 disposed between the sensor main unit 22A and the edge 5A of the door hem 5 is integrally formed with the covering member 22B. The covering member 22B may be referred to as an “outer cover portion”. A water-drop prevention portion 31 is formed in lip-shape extending toward the edge 5A of the door hem 5 such that the water-drop prevention portion 31 spreads over the edge 5A of the door hem 5. In other words, the water-drop prevention portion 31 is formed being folded back in a direction opposite to the direction D2 in which water flows toward the detection surface 7 of the differential capacitance sensor 22 from the outer surface of the door hem 5. It is to be noted that the covering member 22B and the spacer 21 are formed of elastic material such as synthetic rubber and other resin material.

In the installation structure S2, because the sensor 22 and the spacer 1 are integrally constructed, a process for attaching the spacer 21 to the bracket 3 can be omitted, which is different from the installation structure S1 according to the embodiment. In short, in the installation structure S2, when the sensor 22 is installed on the door hem 5, the spacer 1 is also attached to the door hem 5 at the same time. Thus, in accordance with the installation structure S2, it is possible to improve workability of a process for installing the sensor 22 to the door hem 5 as well as to reduce the number of components.

In the installation structure S2, a groove and/or a gap (not shown) may be formed on a surface of the spacer 21 being in contact with the edge 5A of the door hem 5 so as to form portions corresponding to the spacing portion 13 and the buffering portion 14 (refer to FIG. 2) in the installation structure S1 according to the embodiment.

Although, in the embodiment, it is assumed that the sensor 2 is used for an apparatus which prevents an object from being caught by the power slide door 4, the present invention is not limited to this, and the installation structure S1 may be applied to a hinged door.

In the embodiment, the spacer 1 is formed of elastic material such as synthetic rubber and other resin material, however, the spacer 1 may be formed of inelastic material if the buffering portion 14 is not formed.

The embodiments according to the present invention have been explained as aforementioned. However, the embodiment of the present invention is not limited to those explanations, and those skilled in the art ascertain the essential characteristics of the present invention and can make the various modifications and variations to the present invention to adapt it to various usages and conditions without departing from the spirit and scope of the claims.

1. A structure for installing to a door of a vehicle a capacitance sensor which detects an object in vicinity of the capacitance sensor, comprising:
a spacer provided between the door and the capacitance sensor disposed at a vehicle-inner side of an opening end of the door, the spacer having a water-drop prevention portion formed on an outer surface of the spacer for preventing water from flowing to the capacitance sensor from the door.

2. The structure of claim 1, wherein the water-drop prevention portion is formed in a lip-shape to be folded backward in an opposite direction to a water flowing direction.

3. The structure of claim 1, wherein the spacer comprises:
a spacing portion which is in contact with the door and the capacitance sensor, and
a buffering portion which is a space formed along at least one of the door and the capacitance sensor.

4. The structure of claim 2, wherein the spacer comprises:
a spacing portion which is in contact with the door and the capacitance sensor, and
a buffering portion which is a space between the spacing portion and at least one of the door and the capacitance sensor.

5. The structure of claim 1, wherein the spacer comprises:
a door-side engaging portion for engaging an edge of the door; and
a bracket-side engaging portion for engaging a bracket which connects the capacitance sensor to a vehicle-inner side of the door.

6. The structure of claim 2, wherein the spacer comprises:
a door-side engaging portion for engaging the edge of the door; and
a bracket-side engaging portion for engaging a bracket which connects the capacitance sensor to a vehicle-inner side of the door.

7. The structure of claim 3, wherein the spacer comprises:
a door-side engaging portion for engaging the edge of the door; and
a bracket-side engaging portion for engaging a bracket which connects the capacitance sensor to a vehicle-inner side of the door.

8. The structure of claim 4, wherein the spacer comprises:
a door-side engaging portion for engaging the edge of the door; and
a bracket-side engaging portion for engaging a bracket which connects the capacitance sensor to a vehicle-inner side of the door.

9. The structure of claim 1, wherein the spacer is integrally formed with an outer cover portion of the capacitance sensor.

10. The structure of claim 2, wherein the spacer is integrally formed with an outer cover portion of the capacitance sensor.

11. The structure of claim 3, wherein the spacer is integrally formed with an outer cover portion of the capacitance sensor.

12. The structure of claim 4, wherein the spacer is integrally formed with an outer cover portion of the capacitance sensor.

13. The structure of claim 5, wherein the spacer is integrally formed with an outer cover portion of the capacitance sensor.

14. The structure of claim 6, wherein the spacer is integrally formed with an outer cover portion of the capacitance sensor.

15. The structure of claim 7, wherein the spacer is integrally formed with an outer cover portion of the capacitance sensor.

16. The structure of claim 8, wherein the spacer is integrally formed with an outer cover portion of the capacitance sensor.

17. A method for assembling an installation structure of a capacitance sensor attached to a vehicle inner side of an opening end of a door of a vehicle via a bracket, in which a spacer is sandwiched between the capacitance sensor and the door, the spacer comprising a door-side engaging portion for engaging an edge of the door, and a bracket-side engaging portion for engaging a bracket which connects the capacitance sensor to a vehicle-inner side of the door, and a water-drop prevention portion for preventing water from flowing to the capacitance sensor from the door, the method comprising steps of:
connecting the capacitance sensor to the bracket and engaging the bracket-side engaging portion with the bracket so as to form a sensor unit including the capacitance sensor, the spacer and the bracket;
engaging the door-side engaging portion of the spacer included in the sensor unit with the edge of the door; and
attaching the bracket included in the sensor unit to the vehicle-inner side of the door.
